(19) United States
(12) Patent Application Publication
(10) Pub. No.: US 2026/0310596 A1
(43) Pub. Date: Oct. 8, 2026

(54) ARTIFICIAL INTELLIGENCE ENGINE (AIE) WITH MULTIPLE CORES AND SHARED MEMORY

(71) Applicant: XILINX, INC., San Jose, CA (US)

(72) Inventors: Juan J. NOGUERA SERRA, San Jose, CA (US); Baris OZGUL, Dublin (IE); Francisco BARAT QUESADA, Erembodegem (BE); Alejandro RICO CARRO, Austin, TX (US); Javier CABEZAS RODRIGUEZ, Austin, TX (US); Sneha Bhalchandra DATE, San Jose, CA (US)

(21) Appl. No.: 19/170,430

(22) Filed: Apr. 4, 2025

(51) Int. Cl. G06F 12/02

(52) U.S. Cl. CPC G06F 12/0223

(57) ABSTRACT

A data processing element (DPE), such as an artificial intelligence engine (AIE), with multiple cores and local data memory (LDM), where the DPEs include arbitration circuitry that synchronizes access to the LDM by the respective processing cores. An integrated circuit device may include multiple DPEs and configurable interconnects to permit selectable DPEs to communicate with one another (e.g., to access the LDMs of one another). A DPE may include additional arbitration circuitry to permit the cores of the DPE to access the LDM of another DPE via the same path. A DPE may include multiplexer circuitry to permit the cores of the DPE to communicate with cores of another DPE via the same path. The cores within a DPE may execute respective kernels of an application program in parallel, and may exchange data related to the kernels with one another via the LDM of the DPE.

### TECHNICAL FIELD

Examples of the present disclosure generally relate to data processing elements (DPEs), such as artificial intelligence engines (AIEs), with multiple cores and shared memory.

### BACKGROUND

A data processing element (DPE), such as an AIE, may execute two kernels of an application program sequentially. Sequential execution of the kernels may be time consuming.

### SUMMARY

Techniques for implementing data processing elements (DPEs), such as artificial intelligence engine (AIE), with multiple cores and shared memory are described. One example is an integrated circuit (IC) device that includes multiple data processing elements (DPEs) and a configurable interconnect network to permit selectable ones of the DPEs to communicate with one another, where a first one of the DPEs includes multiple processing cores, local data memory (LDM), and arbitration circuitry to arbitration access to the LDM by the processing cores.

Another example described herein is an IC device that includes multiple data processing elements (DPEs), each including multiple processing cores, LDM, and arbitration circuitry to synchronize access to the LDM by the processing cores of the corresponding DPE, where the processing cores within each of the DPEs execute respective kernels of an application program in parallel.

Another example described herein is a system that includes a graphics processing unit (GPU), where the GPU includes a GPU core having multiple instruction processors, and multiple DPEs), each including multiple processing cores, LDM, and arbitration circuitry to synchronize access to the LDM by the processing cores of the corresponding DPE, where the processing cores within each of the DPEs execute respective kernels of an application program in parallel, and exchange data related to the kernels with one another via the LDM of the corresponding DPE.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an integrated circuit device that includes a data processing element (DPE), according to an embodiment.

FIG. 2 depicts a system that includes an array of DPEs, according to an embodiment.

FIG. 3 depicts a portion of the array, according to an embodiment.

FIG. 4 depicts a DPE, according to an embodiment.

FIG. 5 depicts features of cores of the DPE of FIG. 4, according to an embodiment.

FIG. 6 depicts local data memory (LDM) of the DPE of FIG. 4, according to an embodiment.

FIG. 7 depicts broadcast circuitry of the DPE of FIG. 4, according to an embodiment.

FIG. 8 depicts a system in which the array of FIG. 2 is integrated within a graphics processing unit (GPU), according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe data processing elements (DPEs), such as artificial intelligence engines (AIEs), with multiple cores and shared local memory. The cores may execute respective kernels of an application program in parallel, and may exchange data related to the application program with one another via the shared local memory.

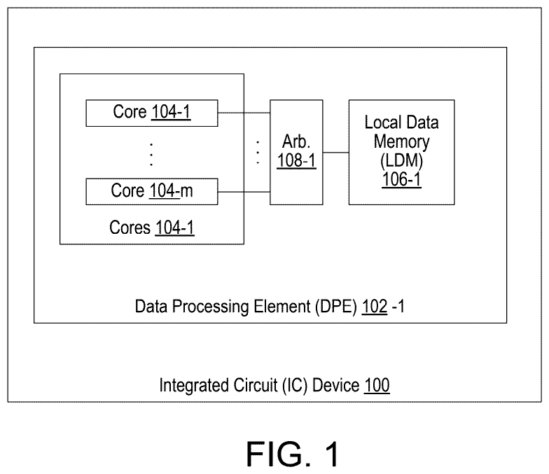

FIG. 1 depicts an integrated circuit device 100 that includes a data processing element (DPE) 102-1, according to an embodiment. DPE 102 includes multiple processor cores (cores) 104-1 through 104-m (collectively, cores 104), and local data memory 106. DPE 102-1 further includes arbitration circuitry 108 to control access to local data memory 106 by cores 104. DPE 102-1 may be implemented as part of an array of DPEs, such as described below.

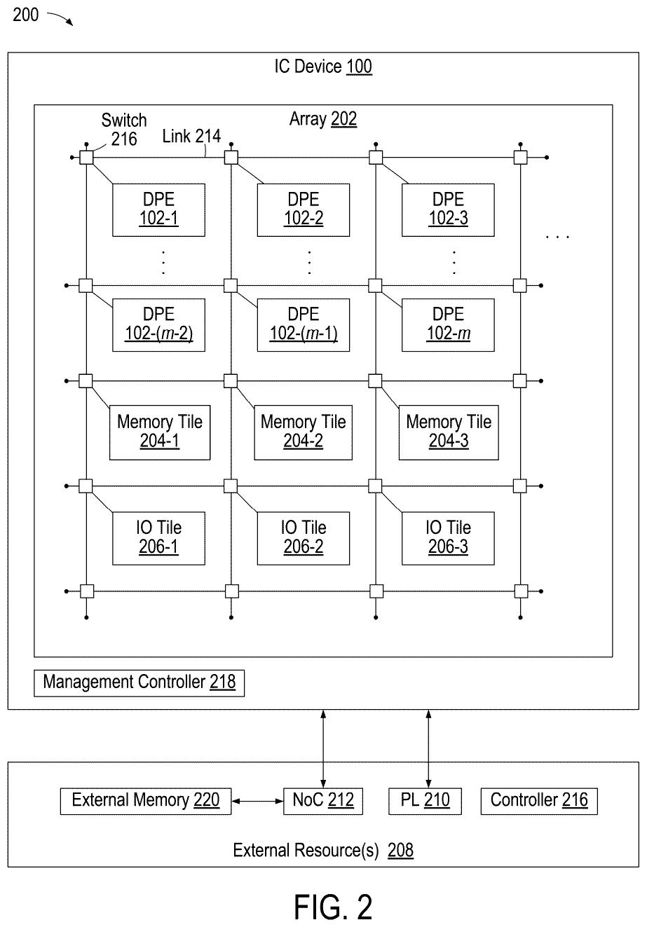

FIG. 2 depicts a system 200 that includes an array of DPEs, according to an embodiment. In the example of FIG. 2, IC device 100 include a data processing array (array) 202, that includes DPEs 102-1 through 102-m (collectively, DPEs 102). Array 202 may further include one or more memory tiles, depicted here as memory tiles 204-1 through 204-3 (collectively, memory tiles 204). Each memory tile 204 may be accessible to one or more DPEs 102. Array 202 may further include one or more interface tiles, depicted here as input/output (IO) tiles 206-1 through 206-3 (collectively, IO tiles 206). IO tiles 206 may interface between external resource(s) 208 and DPEs 102, memory tiles 204, and/or subsets thereof. External resources 208 may include, for example and without limitation, programmable logic 210, a packet-based network-on-chip (NoC) 212, external memory 220, and a controller. Array 202 further includes a configurable interconnect network that includes links 214 and switches 216. Switches 216 may be configurable and may be incorporated within DPEs 102, memory tiles 204, and/or IO tiles 206, examples of which are provided further below. IC device 100 may further include a management controller 218, which is described further below.

In FIG. 2, IC device 100 may further include programmable logic and associated configuration random-access memory (CRAM) to store configuration data for the programmable logic.

DPEs 102, or a subset thereof, may be substantially identical to one another. Alternatively, DPEs 102, or a subset thereof, may differ from one another. DPEs 102, or a subset thereof, may include instruction processors and memory. Alternatively, or additionally, DPEs 102, or a subset thereof, may be implemented with logic (e.g., combinational and/or sequential logic), with or without an instruction processor.

One or more DPEs 102 may be implemented or customized for a particular application. Customization may include compiling an application program specifically for DPEs 102. In an example, one or more DPEs 102 is implemented or customized for artificial intelligence (AI) applications (i.e., machine learning applications). Such DPEs may be referred to as artificial intelligence engines (AIEs). Alternatively, or additionally, one or more DPEs 102 may be implemented or customized for wireless applications, forward error correction applications, and/or other applications.

LDMs of one or more DPEs 102 may be accessible to other DPEs 102. DPEs 102 may exchange data and/or instructions with one another via the LDMs.

The cores of a DPE may execute respective kernels of an application program in parallel with one another, and may exchange data related to the kernels with one another via the LDM.

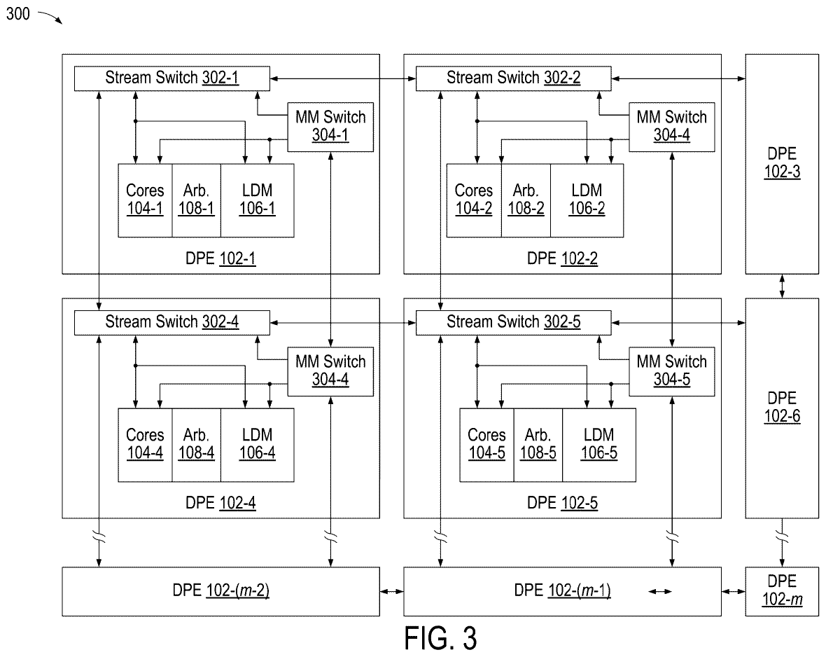

FIG. 3 depicts a portion of array 202, according to an embodiment. In the example of FIG. 3, DPE 102-1 further includes a stream switch 302-1, and a memory mapped (MM) switch 304-1. DPE 102-2 includes cores 104-2, LMD 106-2, arbitration circuitry 108-2, a stream switch 302-2, and a MM switch 304-2. DPE 102-4 includes cores 104-4, LMD 106-4, arbitration circuitry 108-4, a stream switch 302-4, and a MM switch 304-4. DPE 102-5 includes cores 104-5, LMD 106-5, arbitration circuitry 108-5, a stream switch 302-5, and a MM switch 304-5. In FIG. 1, and switches 116 may include stream switches 302 and MM switches 304.

Stream switches 302 may provide communications within DPEs 102, amongst DPEs 102, and/or with other systems, circuits, and/or devices, such as external resource(s) 208. Stream switches 302 may be configurable to connect with selected components of IC device 100. Stream switches 302 may be configurable/programmable to form clusters of DPEs 102 that exchange data, such as application data generated and/or operated on during runtime.

Stream switches 302 may be configurable to operate as a circuit-switching stream interconnect or a packet-switched stream interconnect. A circuit-switching stream interconnect may serve as a point-to-point communication channel, which may be dedicated to high-bandwidth communications among DPEs 102. A packet-switching stream interconnect may serve as a shared (e.g., time-multiplexed) communication channel for medium-bandwidth data streams. Stream switches 302 may be configurable/programmable to establish connections amongst DPEs 102, or subsets thereof.

MM switches 304 may form a memory-mapped network in which MM switches 304 dynamically route transactions based on addresses. The memory-mapped network may also be referred to as a transaction-switched network. The memory-mapped network may be used to communicate data, commands, and/or bits for configuration, control, and/or debugging. The memory mapped network may have access to all storage elements (e.g., memory, registers, latches, and/or other storage elements) of array 202, or a subset thereof. MM switches 304 may permit other circuits/devices to access resources of array 202. In an example, array 202 is mapped to an address space of management controller 218, to permit management controller 218 to access storage elements of DPEs 102. Management controller 218 may use the memory-mapped network to provide configuration bits, such as described further below.

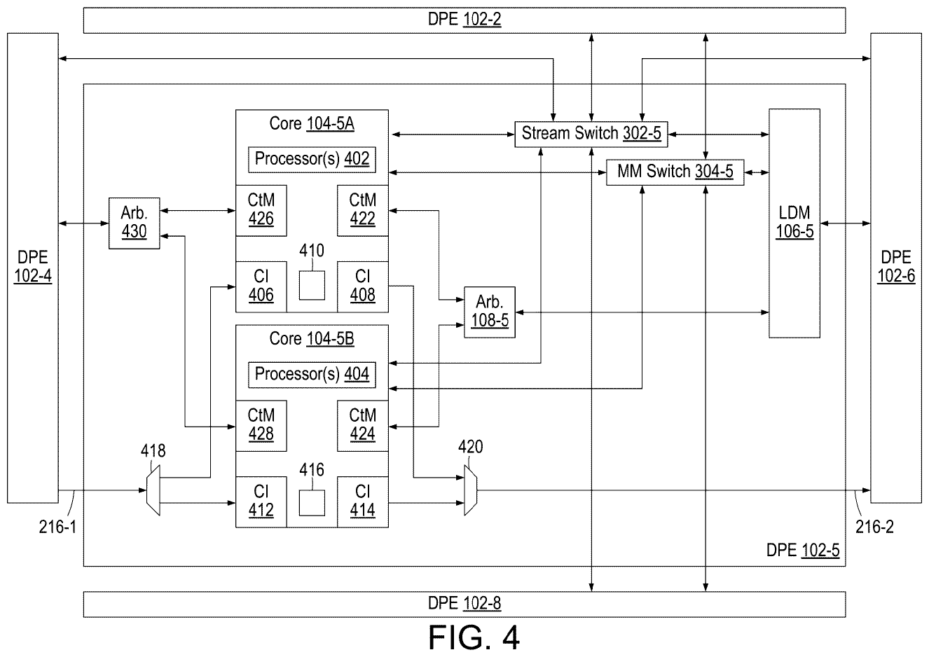

FIG. 4 depicts DPE 102-5, according to an embodiment. Other DPEs 102 may be similar or identical to DPE 102-5. In the example of FIG. 4, cores 104-5 include cores 104-5A and 104-5B. Core 104-5A includes an instruction processor(s) 402. Core 104-5B includes an instruction processor(s) 404. Instruction processor(s) 402 and/or instruction processor(s) 404 may include, for example and without imitation, a central processing unit (CPU,) a graphics processing unit (GPU), a digital signal processor (DSP), a vector processor, a very long instruction word (VLIW) vector processor, and/or other type(s) of processor(s). Alternatively, or additionally, one or more of instruction processor(s) 402 and/or 404 may be implemented with hardware-based logic (e.g., combinational logic and/or sequential logic). Alternatively, or additionally, one or more processor(s) 402 and/or 404 may include customized architecture to support an application-specific instruction set.

Cores 104-5 may further include cascade interfaces (CIs) that provide direct communications with adjacent DPEs. In the example of FIG. 4, core 104-5A includes CIs 406 and 408 that interface with DPEs 102-4 and 102-6. In an example, CI 406 serves as an input CI, and CI 408 serves as an output CI. In this example, CI 406 may receive an input data stream from DPE 102-4, and may provide the data stream to processor(s) 402 and/or to CI 408, which may forward the data stream to DPE 102-6. CIs 406 and 408 may convey multi-bit data streams (e.g., tens or hundreds of bits in width). CIs 406 and 408 may include first-in-first-out (FIFO) buffers. CIs 406 and 408 may be controlled by processor(s) 402. In an example, processor(s) 402 may execute instructions to read from and/or write to CI 406 and and/or CI 408. Alternatively, or additionally, core 104-5A may include hardwired logic to read from and/or write to CI 406 and/or CI 408. Alternatively, or additionally, CI 406 and/or CI 408 may be controlled by management controller 218 and/or another device.

Core 104-5A may further include an internal register(s) 410. Internal register(s) 410 may store data received via CI 406, and/or data generated and/or operated on by processor(s) 402. Internal register(s) 834 may include an accumulation register that stores intermediate results of operations performed by processor(s) 402. An accumulation register may be useful to free processor(s) 402 from writing intermediate results to LDM 106-5 and/or other memory device, which may save time and/or resources. Internal register(s) 834 may further include an additional register(s) that receives data via CI 406. In this example, CI 406 may write the received data to the additional register and/or may output the received data via CI 408 in a cascaded fashion. CIs 406 and 408 may transfer data on each clock cycle. CIs 406 and 408 may cascade internal register(s) 834 with internal register(s) of other DPEs 102.

Core 105-5B may be similar or identical to core 105-5A, or may differ from core 105-5A. In the example of FIG. 4, core 105-5B includes CIs 412 and 414, and an internal register 416, which may function as described above with respect to CIs 406 and 408 and internal register(s) 410. Cores 104-5 may further include multiplexer circuitry 418 to permit CIs 406 and 412 to receive data from DPE 102-4 via the same link(s) 216-1. Cores 104-5 may further include multiplexer circuitry 420 to permit CIs 408 and 414 to send data to DPE 102-6 via the same link(s) 216-2.

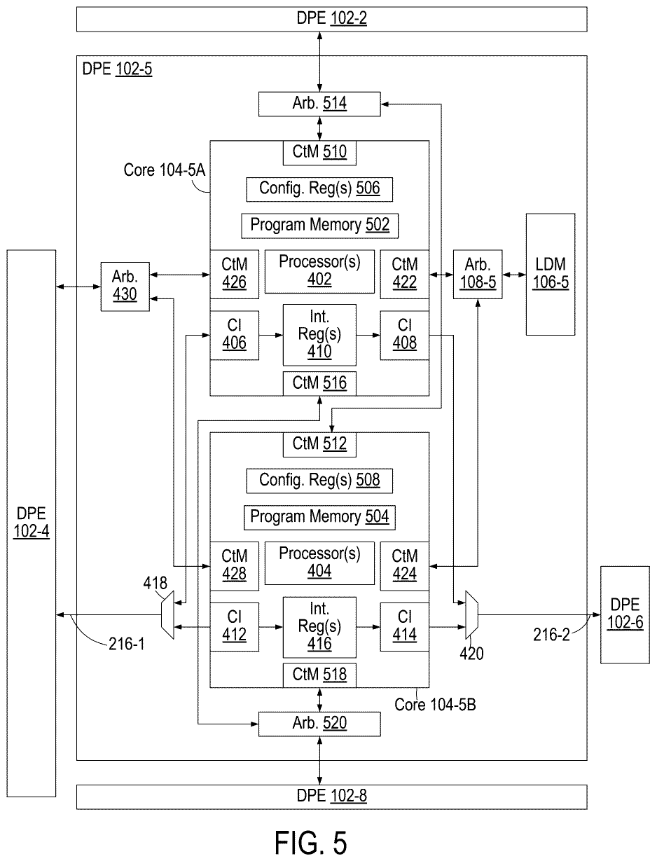

Cores 104-5A and 104-5B may further include core-to-memory (CtM) interfaces 422 and 424 to permit cores 104-5A and 104-5B to access LDM 106-5 (i.e., via arbitration circuitry 108-5). Cores 104-5A and 104-5B may additional CtM interfaces to access LDMs of adjacent DPEs. In the example of FIG. 4, cores 104-5A and 104-5B include additional CtM interfaces 426 and 428 to access the LDM of adjacent DPE 102-4, via arbitration circuitry 430. Additional examples are provided further below with reference to FIG. 5. Alternatively, arbitration circuitry 430 may be placed within DPE 102-4.

Cores 104-5A and 104-5B may map/route read and/or write operations through respective CIs and/or CtM interfaces based on addresses of the respective operations. Cores 104-5A and 104-5B may decode addresses of received data to determine forwarding destinations of the received data, and/or may assign addresses to data generated by Cores 104-5A and 104-5B based on intended destinations of the generated data.

FIG. 5 depicts features of cores 104-5, according to an embodiment. In FIG. 5, stream switch 302-5 and MM switch 304-5 are omitted for clarity/simplicity. In the example of FIG. 5, cores 104-5A and 104-5B include respective program memory 502 and 504 that store instructions for execution by processor 402 and 404. The instructions may be provided by management controller 218

Cores 104-5A and 104-5B may further include configuration random-access memory (CRAM), depicted here as configuration registers 506 and 508, which management controller 218 may load with configuration bits (e.g., via MM switch 304-5) to control functions/operations of DPE 102-5. Configuration registers 506 and 508 may be addressable via the memory mapped network of MM switches. Configuration registers 506 and 508 may control, for example and without limitation, configuration of respective cores 104-5A and 104-5B, configuration of stream switch 302-5, configuration of respective CtM interfaces, and/or configuration of respective CIs. The configuration registers may, for example, enable/disable CIs, enable/disable selected ports of stream switch 302-5, and/or configure stream switch 302-5 for packet-switched operation or circuit-switched operation. The configuration registers may enable/disable DPE 102-5, or portions thereof. The configuration registers may control configuration of LDM 106-5. In an example, the configuration registers may disable cores 104-5 and enable LDM 106-5, such that LDM 106-5 is accessible to one or more other DPEs.

In an example, one of cores 104-5 may be designated a master core, remaining cores 104-5 may be designated slave cores, and the configuration registers of the master core may control configuration of LDM 106-5. In another example, configuration registers of all but one of cores 104-5 are unused.

Cores 104-5A and 104-5B may further include CtM interfaces 510 and 512, and DPE 102-5 includes additional arbitration circuitry 514, to permit cores 104-5A and 104-5B to access an LDM of DPE 102-2. In FIG. 5, cores 104-5A and 104-5B include additional CtM interfaces 510 and 512, and DPE 102-5 includes additional arbitration circuitry 514, to permit cores 104-5A and 104-5B to access an LDM of DPE 102-2.

Cores 104-5A and 104-5B may further include CtM interfaces 516 and 518, and DPE 102-5 includes additional arbitration circuitry 520, to permit cores 104-5A and 104-5B to access an LDM of DPE 102-8. In FIG. 5, cores 104-5A and 104-5B include additional CtM interfaces 510 and 512, and DPE 102-5 includes additional arbitration circuitry 514, to permit cores 104-5A and 104-5B to access an LDM of DPE 102-8. One of cores 104-5A and 104-5B may, for example, include hard logic (e.g., combinational and/or sequential logic) specifically designed or configured to perform matrix multiplication and/or convolution.

In the example of FIG. 5, cores 104-5A and 104-5B are substantially identical to one another. In another example, cores 104-5A and 104-5B differ from one another.

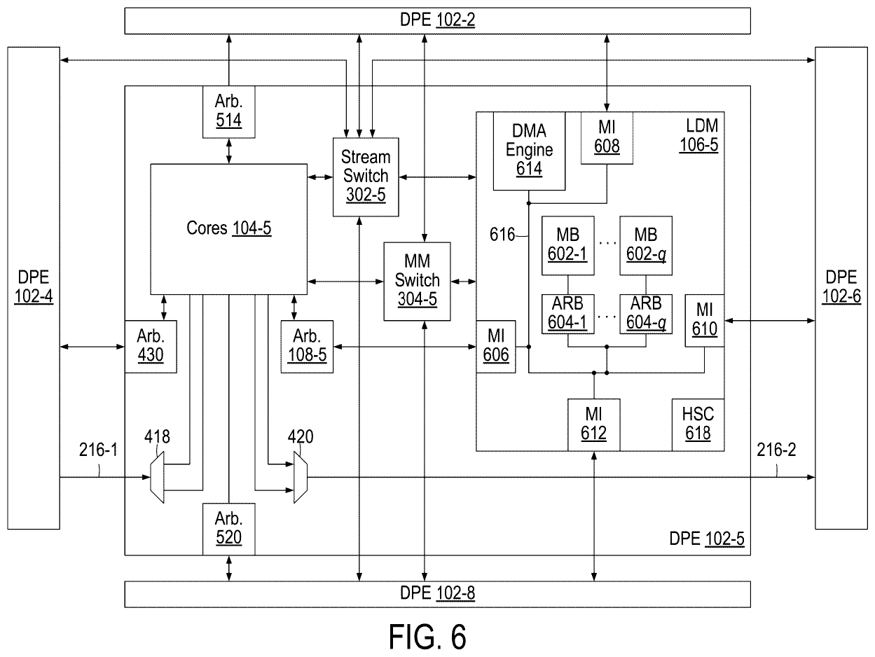

FIG. 6 depicts features of LDM 106-5, according to an embodiment. In the example of FIG. 6, LDM 106-5 includes one or more banks of memory and associated arbitration logic, depicted here as memory banks (MBs) 602-1 through 602-q, and arbitration logic (ARB) 604-1 through 604-q. ARBs 604 may include crossbars to permit writing to selectable ones of MBs 602.

LDM 106-5 further includes a memory interface (MI) 606 that permits cores 104-5 to access MBs 602 via arbitration circuitry 108-5. LDM 106-5 may further include MIs 608, 610, and 612 to permit cores of adjacent DPEs 102-2, 102-6, and 102-8, to access MBs 602 via arbitration circuitry of the respective DPEs.

LDM 106-5 may further include a stream interface (not shown) that interfaces with stream switch 302-5, to permit other DPEs (e.g., non-adjacent DPEs) to access MBs 602 via stream switch 302-5.

LDM 106-5 may further include a direct-memory access (DMA) engine 614. DMA engine 614 may include one or more interfaces to receive data streams from other DPEs, write the received data to MBs 602, read data from MBs 602, and/or send data to other DPEs, via stream switch 302-5.

LDM 106-5 may further include a memory mapped interface (not shown) that interfaces with MM switch 304-5.

LDM 106-5 may further include a communication network 616 to provide communications amongst elements/components of LDM 106-5.

LDM 106-5 may further include hardware synchronization circuitry (HSC) 618 that synchronizes operations of elements/circuits that access MBs 602 (e.g., cores 104-5, cores of other DPEs, DME engine 614, management controller 218, and/or other circuits/devices).

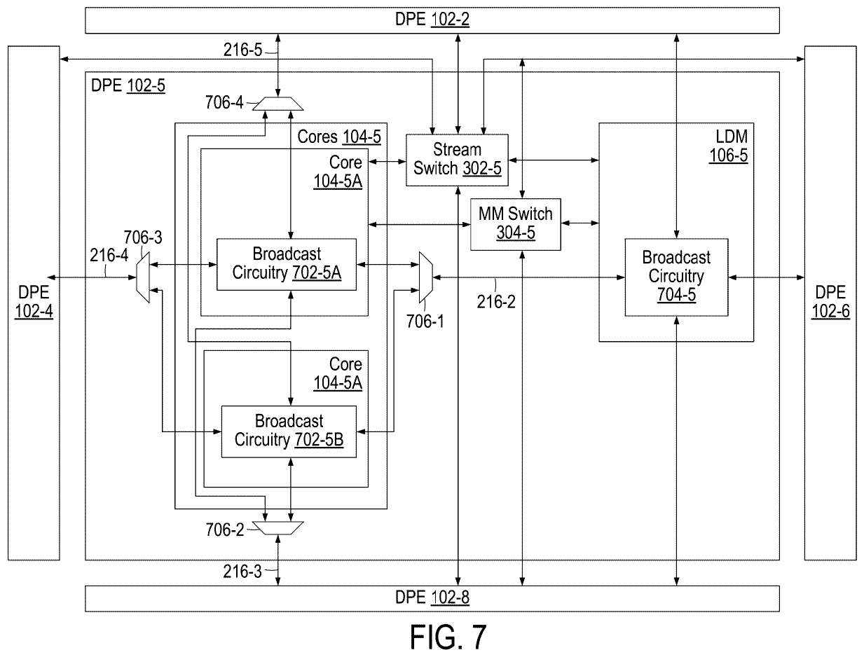

One or more DPEs 102 may further include broadcast circuitry, such as described below with reference to FIG. 7. FIG. 7 depicts broadcast circuitry of DPE 102-5, according to an embodiment. In the example of FIG. 7, core 104-5A includes broadcast circuitry 702-5A, core 104-5B includes broadcast circuitry 702-5B, and LDM 106-5 includes broadcast circuitry 704-5. In other examples, broadcast circuitry 702-5A, 702-5B, and/or broadcast circuitry 704-5 may be omitted. Broadcast circuitry 702-5A, 702-5B and/or 704-5 may be connected to broadcast circuitry of other DPEs 102. In the example of FIG. 7, DPE 102-5 furthers includes multiplexer circuitry 706-1, 706-2, 706-3, and 706-4, to permit broadcast circuitry 702-5A and 702-5B to broadcast events and/or receive broadcast events via the same link(s), 216-2, 216-3, 216-4, and/or 216-5. Broadcast circuitry of multiple DPEs 102 may form a broadcast network, which may be independent of other communication channels of IC device 100. Broadcast circuitry 702-5A, 702-5B and/or 704-5 may be combined with one or more features disclosed herein.

Broadcast circuitry of DPEs 102 may be individually configurable based on configuration bits stored in configuration registers of the respective DPEs. Broadcast circuitry 702-5A, 702-5B and/or 704-5 may, for example, be configurable to detect specified types of events that occur within core 104-5A, core 104-5B, and/or LDM 106-5. Detectable events within core 104-5A and/or core 104-5B may include, without limitation, starts and/or ends of read operations by the respective core, starts and/or ends of write operations by the respective core, stalls, and/or other operations performed core 104-5A and/or core 104-5B. Detectable events within LDM 106-5 may include, without limitation, starts and/or ends of read operations of DMA engine 614, starts and/or ends of write operations by DMA engine 614, stalls, and other operations of LDM 106-5. In other examples, broadcast circuitry 702-5A, 702-5B and/or 704-5 may detect specified types of events that occur within and/or in relation to DMA engine 614, MM switch 304-5, stream switch 302-5, MIs 606 through 610, CtM interfaces 422, 424, 426, 426, and 428, CIs 406, 408, 412, and 414, and/or other components of DPE 104-6.

Configuration registers 506 and/or 508 of DPE 102-5 may control which events generated by DPE 102-5 and/or which events received by broadcast circuitry 702-5A, 702-5B and/or 704-5, are propagated to broadcast circuitry of other DPEs. Configuration registers 506 and/or 508 may control which events are propagated between/amongst broadcast circuitry 702-5A, 702-5B, and 704-5. In an example, broadcast circuitry 702-5A generates events based on conditions within core 104-5A, broadcast circuitry 702-5B generates events based on conditions within core 104-5A, and broadcast circuitry 704-5 generates events based on conditions within LDM 106-5. After configuration bits are written to configuration registers 506 and/or 508 (i.e., via MM switch 304-5), broadcast circuitry 702-5A, 702-5B and 704-5 may operate in the background.

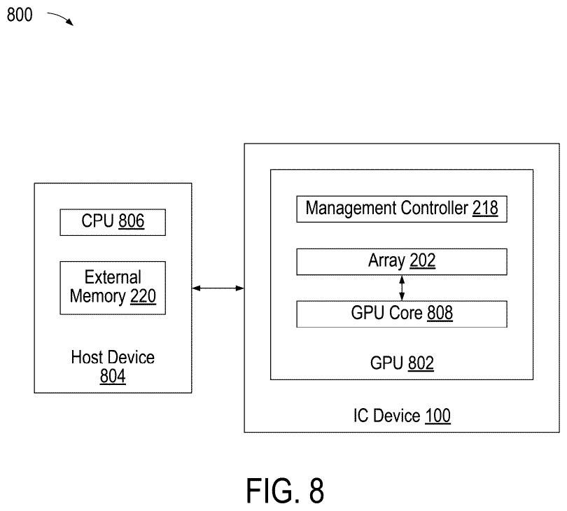

FIG. 8 depicts a system 800 in which array 202 is integrated within a graphics processing unit (GPU) 802, according to an embodiment. In the example of FIG. 8, a host device 804 having a central processing unit (CPU) 806, executes an application program and offloads tasks of the application program to GPU 802. A GPU core 808 assigns aspects of the tasks to array 202, array 202 returns results to GPU core 808, and GPU core 808 returns results to host device 804. The GPU core 808 may include, for example, and without limitations, multiple single-instruction multiple data (SIMD) processors and local data memory.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
multiple data processing elements (DPEs) and a configurable interconnect network configured to permit selectable ones of the DPEs to communicate with one another, wherein a first one of the DPEs comprises:
multiple processing cores;
local data memory (LDM); and
first arbitration circuitry configured to synchronize access to the LDM by the processing cores.

2. The IC device of claim 1, wherein:
the processing cores are configured to execute respective kernels of an application program in parallel.

3. The IC device of claim 1, wherein:
the processing cores are configured to exchange data with one another via the LDM.

4. The IC device of claim 1, wherein the processing cores are configured to:
execute respective kernels of an application program in parallel with one another; and
exchange data related to the kernels with one another via the LDM.

5. The IC device of claim 1, wherein:
the interconnect network comprises a path between the first DPE and a second one of the DPEs;
the processing cores comprise core-to-memory interface circuity configured to access an LDM of the second DPE via the path; and
the IC device further comprises arbitration circuitry configured to synchronize access to the LDM of the second DPE by the processing cores of the first DPE.

6. The IC device of claim 1, wherein:
the configurable interconnect network comprises a path between the first DPE and a second one of the DPEs;
the processing cores comprise cascade interface circuitry configured to permit the processing cores to communicate with processing cores of a second one of the DPEs via the path; and
the first DPE further comprises multiplexer circuitry configured to multiplex access to the path by the processing cores of the first DPE.

7. The IC device of claim 1, wherein:
the interconnect network comprises a path between the first DPE and a second one of the DPEs;
the first DPE comprises multiple broadcast circuits configured to exchange events with the second DPE via the path; and
the first DPE further comprises multiplexer circuitry configured to multiplex access to the path by the broadcast circuits.

8. The IC device of claim 1, further comprising:
a graphics processing unit configured to offload tasks to the DPEs.

9. An integrated circuit (IC) device, comprising:
multiple data processing elements (DPEs), each comprising:
multiple processing cores;
local data memory (LDM); and
arbitration circuitry configured to synchronize access to the LDM by the processing cores of the corresponding DPE;
wherein the processing cores within each of the DPEs are configured to execute respective kernels of an application program in parallel.

10. The IC device of claim 9, wherein the processing cores within each of the DPEs are configured to exchange data related to the kernels with one another via the LDM of the DPE.

11. The IC device of claim 9, wherein one or more of the DPEs is configured to access the LDM of one or more other ones of the DPEs.

12. The IC device of claim 9, further comprising a configurable interconnect network configured to permit selectable ones of the DPEs to communicate with one another, wherein:
the interconnect network comprises a path between a first one of the DPEs and a second one of the DPEs;
the processing cores of the first DPE comprise core-to-memory interface circuity configured to access the LDM of the second DPE via the path; and
the IC deice further comprises arbitration circuitry configured to synchronize access to the LDM of the second DPE by the processing cores of the first DPE.

13. The IC device of claim 9, further comprising a configurable interconnect network configured to permit selectable ones of the DPEs to communicate with one another, wherein:
the interconnect network comprises a path between a first one of the DPEs and a second one of the DPEs;
the processing cores of the first DPE comprise cascade interface circuitry configured to permit the processing cores of the first DPE to communicate with the processing cores of the second DPE via the path; and
the first DPE further comprises multiplexer circuitry configured to multiplex access to the path by the processing cores of the first DPE.

14. The IC device of claim 9, wherein:
the interconnect network comprises a path between the first DPE and a second one of the DPEs;
the first DPE comprises multiple broadcast circuits configured to exchange events with the second DPE via the path; and
the first DPE further comprises multiplexer circuitry configured to multiplex access to the path by the broadcast circuits.

15. The IC device of claim 9, further comprising:
a graphics processing unit configured to offload tasks to the DPEs.

16. A system, comprising:
a graphics processing unit (GPU) comprising:
a GPU core comprising multiple instruction processors; and
multiple data processing elements (DPEs), each comprising:
multiple processing cores;
local data memory (LDM); and
arbitration circuitry configured to synchronize access to the LDM by the processing cores of the corresponding DPE;
wherein the processing cores within each of the DPEs are configured to execute respective kernels of an application program in parallel, and to exchange data related to the kernels with one another via the LDM of the corresponding DPE.

17. The system of claim 16, wherein one or more of the DPEs is configured to access the LDM of one or more other ones of the DPEs.

18. The system of claim 16, further comprising a configurable interconnect network configured to permit selectable ones of the DPEs to communicate with one another, wherein:
the interconnect network comprises a path between a first one of the DPEs and a second one of the DPEs;
the processing cores of the first DPE comprise core-to-memory interface circuity configured to access the LDM of the second DPE via the path; and
the IC deice further comprises arbitration circuitry configured to synchronize access to the LDM of the second DPE by the processing cores of the first DPE.

19. The system of claim 16, further comprising a configurable interconnect network configured to permit selectable ones of the DPEs to communicate with one another, wherein:
the interconnect network comprises a path between a first one of the DPEs and a second one of the DPEs;
the processing cores of the first DPE comprise cascade interface circuitry configured to permit the processing cores of the first DPE to communicate with the processing cores of the second DPE via the path; and
the first DPE further comprises multiplexer circuitry configured to multiplex access to the path by the processing cores of the first DPE.

20. The system of claim 16, wherein:
the interconnect network comprises a path between the first DPE and a second one of the DPEs;
the first DPE comprises multiple broadcast circuits configured to exchange events with the second DPE via the path; and
the first DPE further comprises multiplexer circuitry configured to multiplex access to the path by the broadcast circuits.
